(19) United States
(12) Patent Application Publication
(10) Pub. No.: US 2020/0018849 A1
(43) Pub. Date: Jan. 16, 2020

(54) DEVICE FOR DETECTING PRESENCE BY ULTRASOUND

(71) Applicant: CENTRE NATIONAL DE LA RECHERCHE SCIENTIFIQUE, PARIS (FR)

(72) Inventor: Gabriel VASILE, Grenoble (FR)

(21) Appl. No.: 16/495,398

(22) PCT Filed: Mar. 19, 2018
(86) PCT No.: PCT/EP2018/056893

§ 371 Date: Sep. 19, 2019

(30) Foreign Application Priority Data
Mar. 24, 2017 (FR) 17 52502

(51) Int. Cl. G01S 15/04; G01S 15/10

(52) U.S. Cl. CPC G01S 15/04; G01S 15/104

(57) ABSTRACT

Disclosed is a device for detecting the presence of a target, including a generator, a pair of sensors, and a processing unit that is suitable for: a) receiving and sampling ultrasonic signals; b) obtaining, by Hilbert transform, first and second complex signals; c) filtering, with a matched filter, each of the complex signals; d) associating, with each sample of the filtered first complex signal, the sample of the filtered second complex signal having the best correlation, from which there results one pair of samples for each reception time; e) selecting successive pairs of samples in an interval about each reception time; f) calculating a value of the statistical correlation between the pairs selected in step e); and g) detecting the presence of the target when one of the correlation values deviates significantly from the other correlation values.

### FIELD

The present invention relates to an acoustic device, in particular a device for detecting presence by ultrasound.

### BACKGROUND OF THE INVENTION

Devices for detecting presence by ultrasound are used, for example in certain underwater monitoring applications such as the monitoring of ports or the detection of schools of fish. Such devices are also used in applications for monitoring drifting elements in a river or stream, for example close to water capture points used for hydroelectric production or to cool power plants.

The known devices have presence detection reliability issues, when:
the water is turbulent;
the ultrasounds emitted by the device are reflected by walls, such as the bed of a river;
the elements that one wishes to detect are moving quickly;
the targets reflect the ultrasounds little, for example small debris, for example smaller than a cm, piles of such debris, or soft targets such as jellyfish or plastic bags; or
the turbidity level of the water is high.

### SUMMARY

One embodiment provides an ultrasound detection device, making it possible to resolve all or some of the aforesaid drawbacks.

One embodiment provides a target detection device that is particularly simple to manufacture.

One embodiment provides a device implementing large sensors, for example with a diameter larger than 2.5 cm, that are readily available and easy to implement.

One embodiment provides a device making it possible to detect the presence of targets reflecting the ultrasounds little.

One embodiment provides a device making it possible to detect the presence of targets able to be in motion, in an aquatic environment that may be turbulent and/or turbid.

One embodiment provides a device making it possible to detect the presence of a target reliably in the presence of a wall.

Thus, one embodiment provides a device for detecting the presence of a target, comprising: a generator of an ultrasound train with wavelengths decreasing as a function of time or increasing as a function of time, capable of being reflected by the target; a pair of first and second sensors; and a processing unit suitable for: a) receiving and sampling first and second ultrasound signals coming from an observed region and respectively received by the first and second sensors, resulting in samples of the first and second signals, each sample corresponding to a reception moment; b) obtaining, by Hilbert transform of each of the first and second signals, first and second complex signals; c) filtering, with a matched filter, each of the first and second complex signals; d) associating, with each sample of the filtered first complex signal, the sample of the filtered second complex signal having the best correlation, from which there results one pair of first and second samples of the first and second filtered complex signals for each reception time; e) selecting, for each reception time, successive pairs of samples in an interval about that reception time; f) calculating, for each reception time, a correlation value representative of a statistical correlation between the pairs selected in step e); and g) detecting the presence of the target when at least one of the correlation values deviates significantly from the other correlation values.

According to one embodiment, the correlation value E(tn) for each reception time is defined by the relationship:

$$E ( tn ) = \vert \frac{Cov 12 ( tn )}{\sqrt{Cov 11 ( tn ) \cdot Cov 22 ( tn )}} \vert$$

where Cov designates the covariance matrix of the pairs selected in step e).

According to one embodiment, the first and second sensors are arranged at a center to center distance greater than 4 times the wavelength of the ultrasounds.

According to one embodiment, step a4) comprises: defining a reference line parallel to the axis passing through the first and second sensors; for each reception time, obtaining a phase shift value, representative of the difference between, on the one hand, the measured phase shift and, on the other hand, the theoretical phase shift for the point of the reference line corresponding to the reception time; and determining the distance between the axis of the centers and the target, from the phase shift value.

According to one embodiment, step g) comprises: calculating, for each reception time, an amplitude value representative of the average modulus of the samples of the pairs selected in step e); and detecting the presence of the target when at least one of the amplitude values deviates significantly from the other amplitude values.

According to one embodiment, step g) comprises: calculating, for each reception time, a phase shift value representative of the average difference between the arguments of the first and second samples of the pairs selected in step e); and detecting the presence of the target when at least one of the phase shift values deviates significantly from the other phase shift values.

According to one embodiment, the sensors are suitable for not significantly detecting the ultrasounds coming from directions forming an angle greater than 80° with the axis passing through the sensors.

### BRIEF DESCRIPTION OF THE DRAWINGS

These features and advantages, as well as others, will be described in detail in the following description of specific embodiments done non-limitingly in connection with the attached figures, in which:

FIG. 1 illustrates an embodiment of a device for detecting the presence of a target by ultrasounds;

FIGS. 2A to 2D are timing diagrams schematically illustrating examples of steps carried out by a device for detecting the presence of a target;

FIG. 3 is a side view of a pair of sensors, schematically illustrating an example of another step implemented by a device for detecting the presence of a target.

### DETAILED DESCRIPTION

Same elements have been designated by same references in the various figures and, additionally, various figures are not drawn to scale. In particular, the dimensions of the ultrasound identification devices are exaggerated relative to those of the observed regions in which the targets can be located. For clarity reasons, only the elements useful to understand the described embodiments have been shown and are described.

In the following description, unless otherwise specified, the expressions “substantially” and “on the order of” mean to within 10%, preferably to within 5%, or, regarding an orientation, to within 10 degrees, preferably to within 5 degrees. Unless otherwise specified, the expression “significantly”, regarding a variation of a value or a difference between values, means by more than 5%, preferably by more than 10%.

Unless otherwise specified, the expression “theoretical”, regarding a value at any given point, means that this value can be calculated, according to a theoretical ultrasound propagation model, by assuming that the ultrasounds are reflected by a target at that point. The theoretical model, for example a constant-speed propagation model, is within the reach of one skilled in the art and is not described.

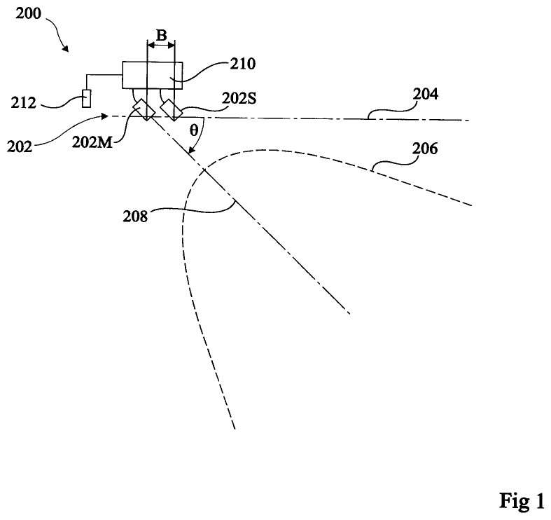

FIG. 1 schematically illustrates an embodiment of a device 200 for detecting the presence of and identifying a target T by ultrasounds.

The device 200 comprises a pair 202 of sensors 202M and 202S. The sensors of the pair are arranged at a center to center distance B, in the direction of an axis 204. The axis 204 passes through the middle of the line of the pairs of sensors.

Each of the sensors 202M, 202S is sensitive to the ultrasounds coming from an observed region 206 that surrounds an observation axis 208. The observation axis 208 forms an angle θ with the axis 204. The observed region can extend from sensors over dimensions greater than a meter, or even much greater than a meter, for example more than 10 m.

As an example, the distance B is several centimeters, for example on the order of 2.5 to 10 cm. The pair of sensors is then in practice quasi-periodic on the scale of the region to be observed.

The sensors are connected to a processing unit 210. As an example, the processing unit comprises a digital circuit, such as a microprocessor suitable for implementing a program recorded in a memory, and analog-digital conversion elements for signals coming from the sensors. The processing unit can be associated with the computer by a remote link, for example by the Internet.

An ultrasound generator 212, connected to the processing unit and preferably separate from the sensors, makes it possible to send ultrasounds toward the observed region 206. The generator 212 can be arranged in the middle of the sensors or in an off-board position. One advantage of an ultrasound generator separate from the sensors is that it can be positioned so as to optimize the reflections of the ultrasounds by the target, based on the configuration of the region to be observed, for example based on the presence of walls such as the riverbed or a seabed.

The generator 212 is provided to emit ultrasound pulses with a wavelength A toward the observed region 208. The wavelength A is typically on the order of 0.15 to 0.5 cm, corresponding in the water to frequencies of between 300 kHz and 1 MHz.

During operation, the pulses are emitted by the generator, reflected by a potential target, and received by the sensors. The processing unit then implements a method making it possible to detect the presence of the target. One example of such a method is described hereinafter in section 1, and a variant is described in section 2. One optional step of the method, for detecting the presence of a target in the presence of a wall, is described in section 3.

### 1. Exemplary Method for Detecting the Presence of a Target

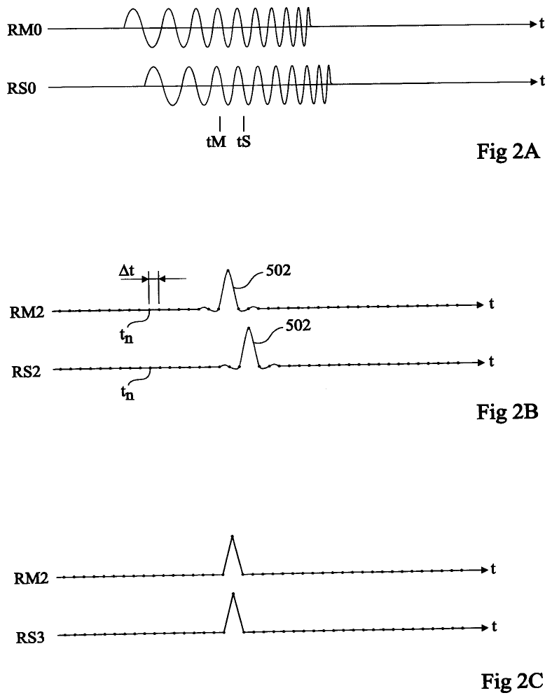

FIGS. 2A to 2D are timing diagrams illustrating examples of steps carried out upon each pulse by the processing unit 210.

In an initial step that is not shown, the ultrasound pulse is generated. The pulse is an ultrasound train with wavelengths λ decreasing as a function of time or increasing as a function of time, capable of being reflected by the target. As an example, the frequency scans the range of frequencies of between 300 kHz and 1.2 MHz. As an example, the total duration of the pulse is between 0.5 ms and 2 ms, for example 1 ms.

In the step of FIG. 2A, each sensor of the pair 202 receives an ultrasound signal. The sensor 202M receives a signal RM0 and the sensor 202S receives a signal RS0, as a function of time t. These signals correspond to the ultrasound train, reflected by a potential target, which reaches the two sensors at times tM and tS (at the center of the received pulses). The central time of the emission of the pulse serves here as time reference t=0, and the time of flight of the ultrasounds thus corresponds to the central reception time. The times tM and tS have a shift as a function of the position of the target. In practice, the duration of the pulse is much greater than the shift between the times tM and tS.

The signals RM0 and RS0 are next sampled. Each sample RM0(tn) or RS0(tn) corresponds to a reception time tn of the ultrasounds by the corresponding sensor. As an example, the sampling frequency 1/Δt of the signal RM0 is substantially equal to 4 times the central frequency of the pulse. As an example, the sampling frequencies are identical for the sampled signals RM0 and RS0. As a variant, the sampling frequency of the signal RS0 is greater than that of the signal RM0, for example 8 times greater.

For each of the signals RM0 and RS0, one next uses a Hilbert transform to determine a sampled complex signal, respectively RM1 and RS1. For each sample RM1(tn) or RS1(tn), the modulus and the argument respectively correspond to the amplitude and the relative phase of the received ultrasounds.

In the step of FIG. 2B, one obtains sampled complex signals RM2 and RS2, by matched filtering of each of the signals RM1 and RS1.

As an example, the suitable filtering of RM1 or RS1 consists, for each time of flight tn, of implementing the relationship:

$$R 2 ( tn ) = {\sum }_{n = - N 1}^{N 1} R 1 ( tn + {n}^{′} ) f 1 ( {tn}^{′} ) Δ t \qquad ( 1 )$$

where R1 is the signal RM1 or RS1,
R2 is the signal RM2 or RS2, and
f1 is a sampled complex signal representative of the ultrasounds emitted by the generator between times t−N1 and tN1, sampled at the frequency 1/Δt and obtained by Hilbert transform.

The signal f1 can correspond directly to the emitted signal, or to a signal received by one of the sensors after propagation in the water, for example measured during a pre-setting phase of the device. As a variant, the signal f1 can be a matched filter reference signal obtained in the manner described in connection with section II and FIG. 2 of the document “Reference Selection for an Active Ultrasound Wild Salmon Monitoring System”, by Vasile G. et al., MTS/IEEE North American OCEANS conference, Washington D.C., USA, published in 2015.

The matched filtering results in concentrating, about a same time, tM for the signal RM2 and tS for the signal RS2, the ultrasounds reflected by a target. One then obtains pulses 502 in each of the signals. As an example, the width of the pulses is on the order of the duration Δt, for example such that in each signal, the pulse 502 only significantly relates to one or two samples. For each sample RM2(tM) or RS2(tS), the modulus and the argument are respectively representative of the amplitude and the relative phase of the ultrasounds reflected by the target.

In the step of FIG. 2C, associated with each sample RM2(tn) of the signal RM2 is the sample RS2(tn′) for which the signal RS2 has the best correlation with the signal RM2. One obtains a sampled complex signal defined by the relationship RS3(tn)=RS2(tn′). One has thus formed a pair of samples RM2(tn), RS3(tn) for each reception time tn. As an example, the correlation is over a period with duration Δt2, centered on the sample RM2(tn) for the signal RM2 and on the sample RS2(tn′) for the signal RS2.

As a variant, the signal RS2 can be oversampled, for example by a factor 8, before the step of FIG. 6C, or the signal RS2 can have kept the sampling frequency of the signal RS0 in the case where this frequency is higher than that of the signal RM0.

As an example, the signal RS3 can be determined, in the present case of ultrasound pulses, in a manner similar to that described for radar pulses in section 1.3, page 17 of the document “Imagerie Radar à Synthèse d'Ouverture interférométrique et polarimétrique”, Doctoral Thesis by Vasile G., Université de Savoie, France, 2007.

In the step of FIG. 2D, for each reception time tn′, a vector V(tn′) of the samples RM2(tn′) and RS3(tn′) is formed, that is to say:

$$V ( {tn}^{′} ) = ( \begin{matrix}RM 2 ( {tn}^{′} ) \\ RS 3 ( {tn}^{′} )\end{matrix} ) \qquad ( 2 )$$

For each reception time tn, N2 consecutive reception times tn′ are selected closest to the time tn, located between times tn−N2/2 and tn+N2/2. As an example, the imager N2 is shared by all of the reception times. One next determines a covariance matrix Cov(tn) (with size 2×2) of the selected vectors V(tn′).

As an example, the matrix Cov(tn) is sought, for signals corresponding to ultrasounds, in the manner described for radar waves in section IIC, paragraph 2 and equation [13] of the document “Stable scatterers detection and tracking in heterogeneous clutter by repeat pass SAR interferometry” by G. Vasile et al., Asilomar Conference on Signals, Systems, and Computers, Pacific Grove, Calif., USA, p 1343-1347, published in 2010. Thus, the matrix Cov(tn) can be found as solution to the equation:

$$Cov ( {t}_{n} ) = \frac{1}{N 2} {\sum }_{{n}^{′} = n - N 2 / 2}^{n + N2 / 2} \frac{V ( {t}_{{n}^{′}} ) \cdot {V}^{H} ( {t}_{{n}^{′}} )}{{V}^{H} ( {t}_{{n}^{′}} ) \cdot {Cov}^{- 1} ( {t}_{n} ) \cdot V ( {t}_{{n}^{′}} )} \qquad ( 3 )$$

where VH(tn) is the conjugated complex transposed vector of the vector VH(tn), and Cov-1(tn) is the inverse matrix of the matrix Cov(tn). To find this solution, successive iterations can be carried out. The covariance matrix can also be determined through other known methods.

The processing unit here is capable of implementing a phase correlation signal E(t), each value E(tn) of which is defined by the relationship:

$$E ( tn ) = \vert \frac{Cov 12 ( tn )}{\sqrt{Cov 11 ( tn ) \cdot Cov 22 ( tn )}} \vert \qquad ( 4 )$$

where ∥ represents the modulus.

The presence of the target T can then be detected when one E(tn0) of the values of phase correlation signal is above a threshold, for example 0.3. The presence of the target can also be detected when one of the values of the correlation signal deviates significantly from the other values of this signal, for example, deviates by more than 0.3.

The use of a statistical correlation signal between signals received by the two sensors, such as the signal E(t), makes it possible to detect the presence of a target reliably. In particular, it is possible to detect, particularly reliably, the presence of a target that may have a low reflectivity and/or be in motion in a turbulent and/or turbid environment.

### 2. More Particularly Reliable Variant of the Method of Section 1

It is proposed here, as a variant, to complete the method of section 1, in order to still further improve the reliability thereof.

The processing unit measures, for each pair of sensors, as a function of the reception time, in addition to the signal E(t):
a signal with amplitude l(t) of the ultrasounds received by the pair of sensors, for example the amplitude of the ultrasounds received by the sensor 202M; and
a phase shift signal Δϕ(t) between the ultrasound waves received by the sensor 202M and those received by the sensor 202S. The phase shift signal can only be defined for the useful values, which correspond to the times where the amplitude is sufficient to be able to measure the phase shift.

Preferably, the amplitude and phase shift signals are sampled signals with values l(tn) and Δϕ(tn), the reception times tn for example being at regular intervals. One preferred determination example of the measured amplitude and phase shift signals is described hereinafter.

For each reception time, the measured amplitude value l(tn) is further determined by the relationship:

I(tₙ)=v^{H}(t_{n′}).Cov⁻¹(tₙ).V(t_{n′}) (5)

and one determines, as measured phase shift Δϕ(tn), the argument of the element Cov12(tn) (1st row, 2nd column) of the matrix Cov(tn).

Each value l(tn) thus obtained is representative of the moduli of the selected samples RM2(tn′) and RS3(tn′) about the time tn. As a variant, it is possible to choose, for the value l(tn), any value representative of the moduli of the selected samples, for example an average value of these moduli. Furthermore, each value Δϕ(tn) obtained here is representative of the differences between the arguments of each pair RM2(tn′), RS3(tn′) of selected samples. As a variant, it is possible to choose, for the value Δϕ(tn), any value representative of these differences, for example the average value of the differences between the arguments of the selected pairs.

The device can then detect the presence of the target when at least one, l(tn0), of the values of the amplitude signal l(t) crosses a threshold, or deviates from the others of the values of the signal, for example by more than 10%. The device can also detect the presence of the target when at least one, Δϕ(tn), of the values of the phase shift signal Δϕ(t) deviates from the other values of this signal, for example by more than 10%.

According to one advantage, due to the matched filtering, the amplitude and phase shift signals thus measured have an improved signal-to-noise ratio, allowing the detection of a signal reflecting the ultrasounds little.

Furthermore, the device 200 can implement large sensors, for example with a diameter greater than 2.5 cm, the center to center distance B between sensors for example being greater than 4 times the central wavelength of the ultrasounds. One advantage of using large sensors is that they allow a particularly high signal-to-noise ratio and resolution, due to the fact that such sensors have particularly wide frequency ranges. Indeed, the matched filtering allows an even higher signal-to-noise ratio and resolution when the frequency range scanned by the ultrasound train is wide.

The device then detects, with a particularly high reliability, the presence of a target that can have a low reflectivity and/or be in motion, in water that may be turbulent and/or turbid.

### 3. Detection in the Presence of a Wall

Here, one seeks to detect the presence of a target reliably, even in the presence of a wall delimiting the observed region.

To that end, between the steps of FIGS. 2C and 2D, an optional step is implemented that uses the signals RS2 and RS3 of FIG. 2C. This step provides a signal RS3′ that next replaces the signal RS3 in the step of FIG. 2D.

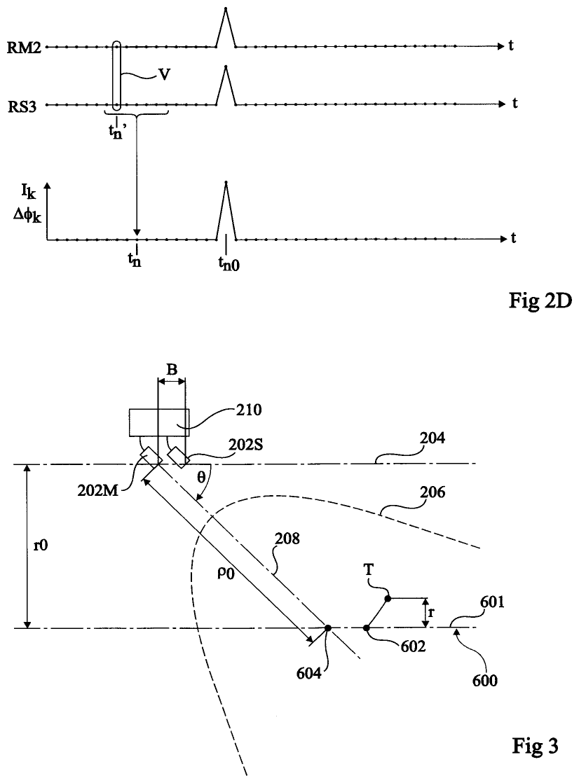

FIG. 3 is a side view of the pair 202 of sensors. As an example, the device has been positioned so that the axis 204 connecting the sensors is parallel to a wall 600 such as the bottom of a river. The wall 600 corresponds to a line 601 in the plane of the figure (i.e., in the plane of the axis 204 and the observation axis 208).

For each sample RS3(tn) of the signal RS3 determined in the step of FIG. 2C, one determines, on the line 601, the point 602 for which the theoretical time of flight corresponds to the reception time tn. One then calculates a value Δψ(tn) representative of the theoretical phase shift Δϕ′(tn) for the point 602. The theoretical time of flight and the theoretical phase shift respectively correspond to the time of flight and the phase shift that are calculated assuming that the ultrasounds are reflected by a target located at a considered point, according to a propagation model of the ultrasounds.

As an example, for a quasi-periodic pair of sensors and a quasi-periodic pair-generator distance on the scale of the sensors-target distance, and to identify a target close to the meeting point 604 between the observation axis 208 and the wall 600 (i.e., a target-point distance 604 much smaller than the sensors-target distance, for example more than 20 times smaller), it is possible to calculate the values Δψ(tn) from the following relationship:

$$Δψ ( tn ) = 2 π ( \frac{B sin θ}{ρ0} tan θ ) \frac{f}{2} tn \qquad ( 6 )$$

where p0 is the distance between the sensor 202M and the point 604,
f is the central frequency of the ultrasound pulses, and
as previously described, θ is the angle between the axes 208 and 204 and B is the distance between the sensors 202M and 202S.

It will be noted that the values Δψ(tn) calculated according to relationship (5) correspond to the theoretical phase shift for the point 602 to which a constant value ψ0 has been added, equal to Δψ(t604)-B cos θ, where t604 is the theoretical time of flight for the point 604. As a variant, in order to obtain the value Δψ(tn), it is possible to add any constant value, i.e., not depending on tn, to the theoretical phase shift Δϕ′(tn) for the point 602.

One next obtains a sampled complex signal RS3′ from the signal RS3 by adding the value Δψ(tn) to the argument for each sample RS3(tn).

The processing unit can next obtain a phase shift value Δϕ1(tn) for each reception time tn from the signals RM2 and RS3′, in a manner similar to that described in connection with FIG. 2D in order to obtain the phase shift signal Δϕ(t) from the signals RM2 and RS3.

The presence of the target T in front of the wall can then be detected when one, Δϕ(tn0), of the values Δϕ1(tn) of the signal Δϕ1(t) deviates significantly from the others of the values of this signal, for example by more than 10%. Indeed, the value Δϕ1(tn0) obtained for one pair of sensors only depends on the distance r of the target from the wall 600, and the value Δϕ1(tn0) corresponds to the target when the other values Δϕ1(tn) correspond to the wall. The presence of a target is detected reliably, even in the presence of a wall reflecting the ultrasounds.

Preferably, the sensors 202M and 202S are suitable for not significantly detecting the ultrasounds coming from directions forming an angle greater than 80° with the axis 204. This makes it possible to obtain values Δψ(tn) sufficient for the phase shift value Δϕ1(tn) to depend essentially on the distance between the target and the axis 204, which makes it possible to detect the target with a high reliability, even in the presence of a wall.

The optional step of this section 3 thus allows a reliable detection of the presence of a target that can have a low reflectivity and/or be in motion, in water that may be turbulent and/or turbid, potentially in the presence of a wall.

### 4. Other Embodiments

The various examples and variants described above can be enhanced to allow the determination of possible positions of the target.

As an example, it is possible to define potential positions of the target in the part of the observed region for which the theoretical time of flight of the ultrasounds corresponds to the reception time tn0 associated with the value E(tn0), l(tn0), Δϕ(tn0) or Δϕ1(tn0).

Furthermore, in the optional step of section 3, it is possible to determine the distance r from the wall of a target close to the point 604. To that end, it is possible to use the value Δϕ1(tn0). Indeed, this value only significantly depends on the distance r.

Furthermore, although a wall is present here as an example, as a variant, the target can be identified by its distance from other surfaces, such as, in the case of a quasi-periodic generator-sensor distance, a cylinder with radius 40 and, as axis, the axis 204. The line 601 is then located at the distance r0 from the axis 204. Indeed, the value Δϕ1(tn0) only significantly depends on the distance between the target and the axis 204. In particular, the constant value ψ0 mentioned above makes it possible for the value Δϕ1(tn0) to be nil when the target is on the cylinder, and the distance between the target and the cylinder is then particularly easy to obtain.

Specific embodiments have been described. Different variants and modifications will appear to one skilled in the art. In particular, methods for detecting a potential target have been described here as an example. It will be noted that these methods can be used to detect the presence of several targets and optionally to identify several targets.

Furthermore, although in the variant of section 2, the measured amplitude l(t) and phase shift Δϕ(t) signals have been determined in a specific manner, it is possible to measure the amplitude and phase shift using any suitable method. As an example, each value l(tn) can be representative of the moduli of the samples RM2(tn) and RS3(tn), for example the average of the moduli. As an example, each value Δϕ(tn) can be the difference between arguments of the samples RS3(tn) and RM2(tn).

1. A device for detecting the presence of a target (T), comprising:
a generator (212) of an ultrasound train with wavelengths (λ) decreasing as a function of time or increasing as a function of time, capable of being reflected by the target;
a pair (202) of first (202M) and second (202S) sensors; and
a processing unit (210) suitable for:
a) receiving and sampling first (RM0) and second (RS0) ultrasound signals coming from an observed region (206) and respectively received by the first and second sensors, resulting in samples of the first (RM0(tn)) and second (RS0(tn)) signals, each sample corresponding to a reception moment (tn);
b) obtaining, by Hilbert transform of each of the first (RM1) and second (RS1) signals, first and second complex signals;
c) filtering, with a matched filter, each of the first and second complex signals;
d) associating, with each sample (RM2(tn)) of the filtered first complex signal (RM2), the sample (RS0(tn′)) of the filtered second complex signal (RS2) having the best correlation, from which there results one pair of first (RM2(tn)) and second (RS3(tn)) samples of the first and second filtered complex signals for each reception time (tn);
e) selecting, for each reception time, successive pairs of samples in an interval (tn−N2/2, tn+N2/2) about that reception time;
f) calculating, for each reception time, a correlation value (E(tn)) representative of a statistical correlation between the pairs selected in step e); and
g) detecting the presence of the target (T) when at least one E(tn0) of the correlation values deviates significantly from the other correlation values.

2. The device according to claim 1, wherein the correlation value E(tn) for each reception time (tn) is defined by the relationship:
$$E ( tn ) = \vert \frac{Cov 12 ( tn )}{\sqrt{Cov 11 ( tn ) \cdot Cov 22 ( tn )}} \vert$$
where Cov designates the covariance matrix of the pairs (RM2(tn′), RS3(tn′)) selected in step e).

3. The device according to claim 1, wherein the first (202M) and second (202S) sensors are arranged at a center to center distance (B) greater than 4 times the wavelength of the ultrasounds.

4. The device according to claim 1, wherein step a4) comprises:
defining a reference line (601) parallel to the axis (204) passing through the first and second sensors;
for each reception time (tn), obtaining a phase shift value (Δϕ1(tn)), representative of the difference between the measured phase shift (Δψ(tn)) and the theoretical phase shift (Δψ(tn)) for the point (602) of the reference line corresponding to the reception time; and
determining the distance between the axis of the centers and the target, from the phase shift value.

5. The device according to claim 1, wherein step g) comprises:
calculating, for each reception time (tn), an amplitude value (I(tn)) representative of the average modulus of the samples of the pairs (RM2(tn′), RS3(tn′)) selected in step e); and
detecting the presence of the target when at least one (I(tn0)) of the amplitude values deviates significantly from the other amplitude values.

6. The device according to claim 1 wherein step g) comprises:
calculating, for each reception time, a phase shift value (Δϕ(tn), Δϕ1(tn)) representative of the average difference between the arguments of the first and second samples of the pairs (RM2(tn′), RS3(tn′)) selected in step e); and
detecting the presence of the target when at least one (Δϕ1(tn0)) of the phase shift values deviates significantly from the other phase shift values.

7. The device according to claim 1, wherein the sensors (202M, 202S) are suitable for not significantly detecting the ultrasounds coming from directions forming an angle greater than 80° with the axis (204) passing through the sensors.

8. The device according to claim 2, wherein the first (202M) and second (202S) sensors are arranged at a center to center distance (B) greater than 4 times the wavelength of the ultrasounds.

9. The device according to claim 2, wherein step a4) comprises:
defining a reference line (601) parallel to the axis (204) passing through the first and second sensors;
for each reception time (tn), obtaining a phase shift value (Δϕ1(tn)), representative of the difference between the measured phase shift (Δϕ(tn)) and the theoretical phase shift (Δψ(tn)) for the point (602) of the reference line corresponding to the reception time; and
determining the distance between the axis of the centers and the target, from the phase shift value.

10. The device according to claim 3, wherein step a4) comprises:
defining a reference line (601) parallel to the axis (204) passing through the first and second sensors;
for each reception time (tn), obtaining a phase shift value (Δϕ(tn)), representative of the difference between the measured phase shift (Δϕ(tn)) and the theoretical phase shift (Δψ(tn)) for the point (602) of the reference line corresponding to the reception time; and
determining the distance between the axis of the centers and the target, from the phase shift value.

11. The device according to claim 2, wherein step g) comprises:
calculating, for each reception time (tn), an amplitude value (I(tn)) representative of the average modulus of the samples of the pairs (RM2(tn′), RS3(tn′)) selected in step e); and
detecting the presence of the target when at least one (I(tn0)) of the amplitude values deviates significantly from the other amplitude values.

12. The device according to claim 3, wherein step g) comprises:
calculating, for each reception time (tn), an amplitude value (I(tn)) representative of the average modulus of the samples of the pairs (RM2(tn′), RS3(tn′)) selected in step e); and
detecting the presence of the target when at least one (I(tn0)) of the amplitude values deviates significantly from the other amplitude values.

13. The device according to claim 4, wherein step g) comprises:
calculating, for each reception time (tn), an amplitude value (I(tn)) representative of the average modulus of the samples of the pairs (RM2(tn′), RS3(tn′)) selected in step e); and
detecting the presence of the target when at least one (I(tn0)) of the amplitude values deviates significantly from the other amplitude values.

14. The device according to claim 2, wherein step g) comprises:
calculating, for each reception time, a phase shift value (Δϕ(tn), Δϕ1(tn)) representative of the average difference between the arguments of the first and second samples of the pairs (RM2(tn′), RS3(tn′)) selected in step e); and
detecting the presence of the target when at least one (Δϕ1(tn0)) of the phase shift values deviates significantly from the other phase shift values.

15. The device according to claim 3, wherein step g) comprises:
calculating, for each reception time, a phase shift value (Δϕ(tn), Δϕ1(tn)) representative of the average difference between the arguments of the first and second samples of the pairs (RM2(tn′), RS3(tn′)) selected in step e); and
detecting the presence of the target when at least one (Δϕ1(tn0)) of the phase shift values deviates significantly from the other phase shift values.

16. The device according to claim 4, wherein step g) comprises:
calculating, for each reception time, a phase shift value (Δϕ(tn), Δϕ1(tn)) representative of the average difference between the arguments of the first and second samples of the pairs (RM2(tn′), RS3(tn′)) selected in step e); and
detecting the presence of the target when at least one (Δϕ1(tn0)) of the phase shift values deviates significantly from the other phase shift values.

17. The device according to claim 5, wherein step g) comprises:
calculating, for each reception time, a phase shift value (Δϕ(tn), Δϕ1(tn)) representative of the average difference between the arguments of the first and second samples of the pairs (RM2(tn′), RS3(tn′)) selected in step e); and
detecting the presence of the target when at least one (Δϕ1(tn0)) of the phase shift values deviates significantly from the other phase shift values.

18. The device according to claim 2, wherein the sensors (202M, 202S) are suitable for not significantly detecting the ultrasounds coming from directions forming an angle greater than 80° with the axis (204) passing through the sensors.

19. The device according to claim 3, wherein the sensors (202M, 202S) are suitable for not significantly detecting the ultrasounds coming from directions forming an angle greater than 80° with the axis (204) passing through the sensors.

20. The device according to claim 4, wherein the sensors (202M, 202S) are suitable for not significantly detecting the ultrasounds coming from directions forming an angle greater than 80° with the axis (204) passing through the sensors.
